(19) United States
(12) Patent Application Publication
(10) Pub. No.: US 2008/0238243 A1
(43) Pub. Date: Oct. 2, 2008

(54) Commutator for an Electric Machine

(75) Inventors: Ronald Gleixner, Hohen Neuendorf (DE); Thomas Schencke, Bernau OT Schonow (DE); Rainer Blumenberg, Berlin (DE)

Correspondence Address: CONTINENTAL TEVES, INC., ONE CONTINENTAL DRIVE, AUBURN HILLLS, MI, 48326-1581, US

(73) Assignee: Conti Temic Microelectroninc GMBH

(21) Appl. No.: 12/065,127

(22) PCT Filed: Aug. 31, 2006
(86) PCT No.: PCT/DE2006/001521

§ 371 Date: Feb. 28, 2008

(30) Foreign Application Priority Data
Sep. 1, 2005 (DE) 10 2005 041 499.0

(51) Int. Cl. H01R 39/04

(52) U.S. Cl. 310/234

(57) ABSTRACT

A commutator for an electric machine with commutator bars, wherein on one side of the commutator which faces a rotor winding, at least one angled retaining element is formed on at least one commutator bar in order to switch contact conductors of the rotor winding, as well as to connect them with the respective commutator bar, wherein the commutator bar comprises two angled retaining elements.

### BACKGROUND OF THE INVENTION

The present invention relates to a commutator for an electric machine with commutator bars, wherein on one side of the commutator which faces a rotor winding, at least one angled retaining element is formed on at least one commutator bar in order to switch contact conductors of the rotor winding, as well as to connect them with the respective commutator bar.

Commutators are required in the field of electrical engineering for commutation in electric machines, in particular, in direct current motors. Here, a differentiation is made between mechanical commutation, which is generally conducted in the form of a bar-brush system, and electronic commutation, in which electronic valves are used which are triggered by an electronic rotor bearing detection unit. Mechanically commutated direct current motors are also known as commutator motors.

Commutator motors are used to drive cooling fans in motor vehicles, for example.

A typical example of a commutator motor of this type comprises two pairs of poles, and therefore four stator poles which are preferably permanently excited, and accordingly, two pairs of brushes with four brushes accordingly. The brushes drag over commutator bars of the commutator.

In order to be able to operate a commutator motor with more than one pair of poles, but with only two brushes, a method is known from DE 197 57 279 C1 for switching commutator bars with approximately double the pole pitch by means of commutator bar contact bridges. Here, the commutator bar contact bridges are also wound with winding wire when winding the armature coils. The contact bridge conductors, together with the wires of the rotor winding, are suspended in grooves which are arranged in the commutator bars.

In particular with motors with a higher capacity, multiple windings are required due to standards specified by the production process, and are switched in parallel on the commutator. As a result, there are several wires on the commutator, in particular on the retaining elements, which must be securely contacted. In particular, the retaining element on the first and the final bar of the winding coils around one more wire. Due to the commutator bar contact bridges, the number of wires to be contacted further increases. As a result, no secure contacting process of the individual wires on the retaining elements is provided.

A method is known from DE 101 16 182 A1 of integrating the bar contact bridges into the commutator. The contact bridges form a component of the commutator, wherein the commutator bars are arranged on the outer circumference of the commutator, and the contact bridges are arranged inside the commutator.

The object of the invention is therefore to further develop a generic commutator in such a manner that coiling several wires around rotors and switching said wires on the commutator is possible without welding and contacting problems arising.

### SUMMARY OF THE INVENTION

This object is attained by commutator (1) for an electric machine with commutator bars (3), wherein on one side of the commutator which faces a rotor winding, at least one angled retaining element (4, 5) is arranged on at least one commutator bar (3) for switching contact conductors of the rotor winding and for contacting with the respective commutator bar. The commutator bar (3) comprises at least two angled retaining elements (4, 5).

The commutator comprises several commutator bars. Furthermore, the commutator comprises at least one angled retaining element for switching the contact conductors, in particular the winding wires, of the rotor winding and for contacting the wires with the respective commutator bar. On the side of the commutator facing the rotor winding, at least two angled retaining elements are arranged.

The advantage of the invention is that due to the provision of at least two angled retaining elements, a secure contacting process of several, i.e. at least three, contact conductors or winding wires can be guaranteed.

In particular, the angled retaining elements and the commutator bar are designed as a single piece. The commutator bar is here designed in such a manner that the retaining elements are curved or angled on the commutator bars.

In an advantageous manner, the retaining elements are arranged adjacent to each other in the direction of the circumference of the commutator bars. If required, the retaining elements can also be arranged one behind the other in the axial direction of the commutator bars.

If the retaining elements are arranged adjacent to each other in the direction of the circumference of the commutator bars, the retaining elements are advantageously arranged axially in the direction of the winding and are offset. This offset arrangement makes a secure winding process possible, in particular, a process for switching the rotor winding. In particular, the retaining element which is used for switching the commutator bar contact bridges, is arranged lower and/or offset in relation to the retaining element which is used for switching the rotor winding.

Preferably, the retaining elements of a commutator bar are arranged in the centre in relation to the commutator bar.

For insulation purposes, the commutator comprises a band between the contact conductors or wires of the rotor winding and the rotor shaft.

Alternatively, the retaining elements arranged on the commutator bar are arranged on the side of the commutator which faces away from the rotor winding.

In particular, the angled retaining elements are designed as hooks and are preferably made of copper.

Additional features and details of the invention will be explained further in the following description with reference to the drawings enclosed and using exemplary embodiments. The features and connections described in individual variants can in general be transferred to all exemplary embodiments. In the drawings:

### BRIEF DESCRIPTION OF THE DRAWINGS

FIG. 1 shows part of a cross-section view of a first embodiment of a commutator according to the invention

FIG. 2 shows a schematic view of a commutator bar according to the first embodiment of the commutator according to the invention

FIG. 3 shows part of a cross-section view of a second embodiment of a commutator according to the invention, and

FIG. 4 shows a schematic view of a commutator bar according to the second embodiment of the commutator according to the invention

### DETAILED DESCRIPTION OF THE DRAWINGS

FIG. 1 shows part of a cross-section view of a first embodiment of a commutator 1 according to the invention. The commutator 1 is arranged on a rotor shaft 2. The commutator comprises several commutator bars 3, wherein only one commutator bar 3 is shown. The commutator bars 3 comprise angled retaining elements 4 and 5, which are arranged adjacent to each other in the direction of the circumference of the commutator bars 3. The retaining elements 4 and 5 are arranged offset in the axial direction, in order to provide a secure winding process. The retaining element 5 is used for switching the commutator bar contact bridges not shown, and is also arranged lower in relation to the retaining element 4, which is used for switching the rotor winding not shown. As can be seen in FIG. 1, the retaining elements 4 and 5 are curved or are angled on the commutator bar 3. For insulation purposes, the commutator 1 comprises a band 6 between the contact conductors or wires of the rotor winding and the rotor shaft 2.

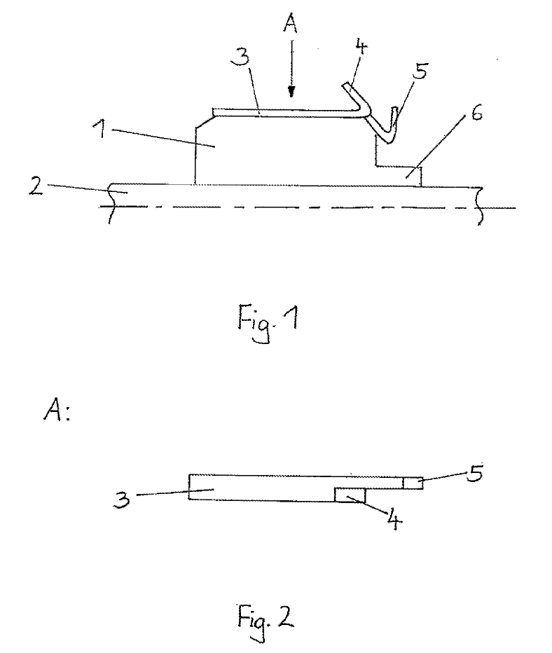

FIG. 2 shows a schematic view of a commutator bar 3 according to the first embodiment. According to this embodiment, the retaining elements 4 and 5 are arranged adjacent to each other. It can be particularly clearly seen in FIG. 2 that the commutator bar 3 and the retaining elements 4 and 5 are formed as a single piece. For this purpose, the commutator bar 3 is first separated or slit at one end, and the retaining elements 4 and 5 are then curved away.

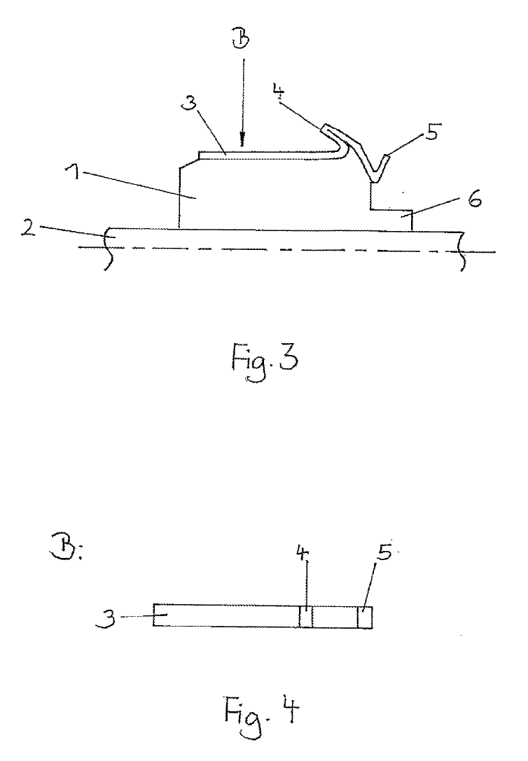

FIG. 3 shows part of a cross-section view of a second embodiment of a commutator 1 according to the invention. The commutator 1 is arranged on a rotor shaft 2. The commutator comprises several commutator bars 3, wherein only one commutator bar 3 is shown. The commutator bars 3 comprise retaining elements 4 and 5, which are arranged one behind the other in an axial direction to the commutator bars 3. The retaining element 5 is used for switching the commutator bar contact bridges not shown, and is also arranged lower in relation to the retaining element 4, which is used for switching the rotor winding not shown. As can be seen in FIG. 3, the retaining elements 4 and 5 are curved. For insulation purposes, the commutator 1 comprises a band 6 between the contact conductors or wires of the rotor winding and the rotor shaft 2.

FIG. 4 shows a schematic view of a commutator bar 3 according to the second embodiment. According to this embodiment, the angled retaining elements 4 and 5 are arranged one behind the other. First, the retaining element 4 is curved, and then the retaining element 5 is curved.

### List of Reference Numerals

1 Commutator
2 Rotor shaft
3 Commutator bar
4 Retaining element
5 Retaining element
6 Band

1-11. (canceled)

12. A commutator (1) for an electric machine having commutator bars (3), the commutator comprising:
a side of the commutator which faces a rotor winding, at least one angled retaining element (4, 5) is arranged on at least one commutator bar (3) for switching contact conductors of the rotor winding and for contacting with the respective commutator bar; and
a commutator bar (3) comprises at least two angled retaining elements (4, 5).

13. A commutator (1) according to claim 12, wherein the retaining elements (4, 5) and the commutator bar (3) are formed as a single piece.

14. A commutator (1) according to claims 12, wherein the retaining elements (4, 5) are arranged adjacent to each other in a direction of circumference of the commutator bars (3).

15. A commutator (1) according to claim 14, wherein at least one retaining element (5) is arranged axially in the direction of the winding, and is offset.

16. A commutator (1) according to claim 12, wherein the retaining elements (4, 5) are arranged one behind the other in the axial direction to the commutator bars (3).

17. A commutator (1) according to claim 12, wherein the retaining elements (4, 5) of a commutator bar (3) are arranged in the centre in relation to the commutator bar (3).

18. A commutator (1) according to claim 12, wherein the retaining elements (4, 5) are curved or angled on the commutator bar (3).

19. A commutator (1) according to claim 12, wherein for insulation purposes, the commutator (1) comprises a band (6) between the wires of the rotor winding and a rotor shaft (2).

20. A commutator (1) according to claim 12, wherein the retaining elements (4, 5) arranged on the commutator bar (3) are arranged on the side of the commutator which faces away from the rotor winding.

21. A commutator (1) according to claim 12, wherein the angled retaining elements (4, 5) are designed as hooks.

22. A commutator (1) according to claim 12, wherein the angled retaining elements (4, 5) are made of copper.
